(19) United States
(12) Patent Application Publication
(10) Pub. No.: US 2021/0307357 A1
(43) Pub. Date: Oct. 7, 2021

(54) SUGAR-CONTAINING PLANT PROTEIN PREPARATION WITH PARTICULAR FUNCTIONAL PROPERTIES

(71) Applicant: FRAUNHOFER-GESELLSCHAFT ZUR FOERDERUNG DER ANGEWANDTEN FORSCHUNG E.V., Muenchen (DE)

(72) Inventors: PETER EISNER, Freising (DE); ISABEL MURANYI, Freising (DE); UTE WEISZ, Freising (DE)

(21) Appl. No.: 17/262,781

(22) PCT Filed: Jul. 23, 2019
(86) PCT No.: PCT/EP2019/069778

§ 371 Date: Jan. 25, 2021

(30) Foreign Application Priority Data
Jul. 30, 2018 (DE) 10 2018 118 339.9

(51) Int. Cl. A23J 3/16; A23J 3/34; A23J 1/14; A23L 29/30

(52) U.S. Cl. CPC A23J 3/16; A23L 29/30; A23J 1/142; A23J 3/346

(57) ABSTRACT

The invention relates to a plant protein preparation made of soybeans having improved functional properties and to a process for the production thereof. The preparation comprises a mixture of proteins and/or constituents of proteins and a proportion of saccharides from the group of mono-, di- and/or oligosaccharides having up to 4 monomer units. The mixture of proteins and/or constituents of proteins has a molecular weight distribution of proteins and peptides in which a mass fraction between 50% and 100% has a molecular weight of <20 kDa, a mass fraction between 0% and 30% has a molecular weight between 20 kDa and 45 kDa and a mass fraction between 0% and 20% has a molecular weight of >45 kDa. The preparation has good technofunctional properties and a pleasantly neutral aroma and taste profile.

### AREA OF APPLICATION

The invention relates to a plant protein preparation made of soybeans with improved functional properties, which contains not only soy protein but also mono- and/or di- and/or oligosaccharides with up to 4 monomer units and offers particular advantages for applications in foodstuffs, in petfood and animal feed.

### RELATED ART

The popularity of plant proteins among consumers is growing. These days, many different plant proteins from legumes, oilseeds or cereal are already used in foodstuffs as a texturising component. At the same time, the proteins serve to stabilise emulsions and foams or to form gels, or they are added to food or drinks as a soluble component to increase the protein content thereof.

However, many of the protein preparations available on the market also have considerable shortcomings in terms of their technofunctional properties, most particularly their emulsifying capacity, solubility, or gel-forming properties. Even the sensory properties of many plant proteins do not satisfy the wishes of the consumers. The taste and aroma profiles of many plant seeds are less than ideal because of the secondary vegetable substances or products of lipid oxidation they contain. Thus, for example, many preparations from soy are described as bitter, beany, grassy or green.

A soy protein isolate which is obtained by calcium chloride extraction is described in EP2482670. It is not specified whether the preparation contains sugar in the form of mono- or disaccharides.

DE112008000924 describes a method for modifying the flavour profile of plant proteins in which the plant protein preparation, in particular a leguminous protein, is contacted with water-soluble carbohydrates in an aqueous solution in order to bring about the desired modification of the flavour profile. In this process, carbohydrates such as glucose, fructose or xylose or mixtures of said substances are used to particularly advantageous effect. The flavour modifying effect of the method will advantageously take place at higher temperatures, above 50° C., and pH values between 3.5 and 5.5. With these values, a particularly neutral flavour is achieved with leguminous proteins, especially with lupin protein. A precise description of the drying conditions or the composition of the proteins is not given.

EP1560501 B1 includes a description of a preparation from lupins which is fermented with lactic acid bacteria to counteract the negative plant-like taste, has a diacetyl content and a content of lactic acid. The document EP1560501 does not include any notes on how soy protein preparations with good functional and sensory properties are obtained.

### PROBLEM ADDRESSED BY THE PRESENT INVENTION

The problem the present invention addressed consisted in providing a protein preparation from soybeans which has good functional properties and possesses a largely neutral flavour profile, and describing a process for the production of the plant protein preparation which can be implemented inexpensively.

### PRESENTATION OF THE INVENTION

The problem is solved with the plant protein preparation made of soy and the method according to Patent claims 1 and 20. Advantageous variants of the preparation and the process for producing the preparation are subject of the dependent claims or can be discerned from the following description and exemplary embodiments. Unless explicitly indicated otherwise, percentage values are understood to refer to percent by mass. Unless explicitly indicated otherwise, the specifications regarding mass fractions relate to the respective fractions by mass of the dry substance of the plant protein preparation.

The plant protein preparation according to the invention contains as the main component (mass fraction greater than 40%, preferably greater than 55%, particularly preferably greater than 65%) a mixture of proteins and/or constituents of proteins, i.e., peptides and/or amino acids, from soybeans. The mass fraction of this mixture preferably constitutes 90% of the plant protein preparation.

In the following text, proteins are understood to be polypeptides which have a number of linked amino acids greater than 100. Peptides are defined by a number of linked amino acids between 2-100. In the plant protein preparation according to the invention, the proteins and peptides are present in a certain ratio, which can be characterized by its molecular weight distribution.

The molecular weight distribution is determined by SDS-PAGE (sodium dodecyl sulfate polyacrylamide gel electrophoresis). In the preparation according to the invention, the molecular weight distribution of the proteins and peptide has the following distribution of molecular weight size classes.

| Molecular weight | Concentration | | Particularly |
|---|---|---|---|
| size | in the range | Preferred | preferred |
| classes [kDa] ¹ | [Mass %] ² | [Mass %] ² | [Mass %] ² |
| >45 | 0-20 | 0-10 | 0-4 |
| 20-45 | 0-30 | 0-20 | 0-13 |
| <20 | 50-100 | 70-100 | 83-100 |

¹ The allergens registered according to the IUIS (International Union of Immunological Societies) are included in the molecular weight size classes.
² Fraction of specific molecular mass distribution relative to the total protein distribution in SDS-PAGE.

According to the invention, the plant protein preparation also contains a saccharide fraction from 2-40%, preferably 10-30%, particularly preferably 20-25%. The saccharides are representatives of the group of mono- and/or di- and/or oligosaccharide with up to 4 monomer units.

Surprisingly, it was found that a combination of the proteins and/or peptides and/or amino acids from the corresponding size class ranges of the soy protein as defined above without a saccharide fraction has a marked beany, leguminous and bitter aroma and taste profile, while the taste impression after the addition of saccharides (preferably mono- and/or disaccharides) is perceived to be considerably more neutral and pleasant with a saccharide content of just 2% and more. Moreover, the taste improving effect of the saccharides is observed more clearly as the fraction of proteins with molecular weights less than 20 kDa increases. As the fraction of smaller proteins and/or peptides in the preparation rises, it also becomes apparent that the functional properties of the plant protein preparation can be improved with an increasing fraction of short-chain peptides. The negative effects of the small proteins and/or peptides (less than 20 kDa) on the sensory properties are largely counteracted by increasing the saccharide content to above 5%. If the saccharide content is increased further to over 20%, it has been found, surprisingly, that despite a significant decrease in the fraction of functional protein and peptide in the preparation no negative effect can be detected on the functional properties per gram of plant protein preparation. In the suggested process for producing the plant protein preparation a protein fraction of the soybeans in aqueous suspension is prepared containing a mixture of proteins and/or constituents of the soybean proteins. The mixture undergoes a hydrolysis process to obtain the desired molecular weight distribution of proteins and peptides in the protein fraction. This may be for example an enzymatic, acid or even a thermal hydrolysis process. The fraction of proteins/peptides with molecular weights less than 20 kDa can be controlled by means of the duration of the hydrolysis process, the temperature selected or the concentration of acid or enzymes.

Sugar containing saccharides from the group of mono- and/or di- and/or oligosaccharides with up to 4 monomer units is added to the aqueous suspension. The sugar is added to the aqueous suspension in such a quantity that after drying the saccharides in the plant protein preparation constitute a mass fraction between 2 and 40% of the plant protein preparation. Finally, the aqueous suspension is dried at a drying temperature of >120° C. to obtain the plant protein preparation.

In an advantageous variant of the process according to the invention, some of the proteins and peptides contained in the soybean is separated before the protein fraction of the soybeans in aqueous suspension is supplied for hydrolysis of the proteins and peptides. These are proteins and peptides which can be washed out from a mechanically crushed soybean (flakes or flour) in water at 20° C. and with a pH of 4.5. More than 50%, advantageously more than 70%, particularly advantageously more than 90% of this fraction is separated with the aid of water for example as the extraction agent. Only then do the remaining proteins and peptides of the soybean undergo hydrolysis.

The preparation according to the invention obtained in this way only contains a correspondingly smaller fraction of these proteins and peptides which are soluble at pH 4.5 than preparations from the natural soybean. Advantageously, the portion of this fraction relative to the total mass of proteins and peptides in the protein preparation will be less than 10%, more advantageously less than 5%, particularly advantageously less than 1%. In the present patent application, a percentage of less than 1% is also understood to mean 0%, that is to say no portion of these proteins and peptides.

In a further advantageous variation of the plant protein preparation according to the invention, besides the named constituents other components are contained in the plant protein preparation or are added during production and can have a positive influence on the overall sensory profile. These are advantageously acid generating microorganisms, preferably from the group of homo- and heterofermentative lactic acid bacteria. Alternatively, the organic acids that are formed by the microorganisms or the corresponding salts may be added to the protein/peptide/amino acid mixture directly. However, the addition of the microorganisms is preferred.

In an advantageous variation, lactic acid is added. It has been found that the addition of lactic acid constituting a mass fraction between 0.05% and 10%, advantageously between 0.1% and 2%, particularly advantageously between 0.1% and 1.5% of the dry substance of the plant protein preparation has a significant influence on the functionality of the preparations. Their emulsifying and foaming properties may be reduced by as much as half or more depending on the quantity they contain.

Mixing differently treated parts of the hydrolysed suspension is an advantageous variation of the process which is carried out with microorganisms. In a first step thereof, the aqueous suspension undergoes hydrolysis together with soy proteins and peptides in order to obtain the desired molecular weight distribution of proteins and peptides. In the second step, the hydrolysed suspension obtained in the first step is divided into at least two parts. One part is reacted with more microorganisms and saccharides than a second part, which is advantageously not reacted with microorganisms at all. After the desired fermentation treatment time of the part containing more microorganisms has passed, the two parts are mixed together again. This results in advantages in the functionality of the preparation obtained thereby, since only a part of the proteins and peptides was subjected to fermentation and the influence of acid, preferably lactic acid, for a prolonged period.

In many cases, the disadvantage of the addition of microorganisms to or the growth of microorganisms in plant protein preparations is that the long period of contact between the proteins and peptides and the acid, for example lactic acid, and the thermal inactivation of the microorganisms for example by pasteurisation results in a deterioration of the functional properties of the plant protein preparation. When two parts which have undergone fermentation at different intensities are mixed, this disadvantage is avoided for the part which is not fermented.

Despite the described detrimental effects on functionality due to the influence of microorganisms, thermal treatment and acid, the sensory properties can be improved by an addition of lactic acid and/or lactic acid generating microorganisms to such a degree that their use is still beneficial. Advantageously, microorganism concentrations (converted into dry mass of the microorganisms) between 1 and 1000 mg per kg dry mass of the plant protein preparation are used, advantageously between 1 and 100 mg/kg, particularly advantageously between 10 and 50 mg/kg.

According to the invention, during production of the plant protein preparation with the indicated saccharide fractions it should be ensured that the saccharides are not mixed with a dry plant protein preparation in the dry form, but instead are dried from aqueous solution together with the aforementioned soy proteins/peptides from the corresponding molecular weight size classes. In this context, with spray drying for example, inlet temperatures >120° C., advantageously >150° C., particularly advantageously >170° C. and outlet temperatures of 50-100° C. should be chosen, because at high temperatures desirable aromas may be engendered as a result of the Maillard reaction, and volatile aromas from the oxidation of the soy lipids may be separated proportionately. Both of these effects improve the sensory properties of the plant protein preparation considerably. It has been found that as the drying temperature rises and the sugar content increases the portion of Maillard reaction products such as Strecker aldehydes or hydroxymethyl furfural (HMF), for example, can also be increased.

The fraction of HMF in the preparation according to the invention is between 0.5 mg/kg dry substance (DS) and 600 mg/kg DS, advantageously between 0.5 and 400 mg/kg, particularly advantageously between 0.5 and 250 mg/kg DS depending on the sugar content and the drying temperature.

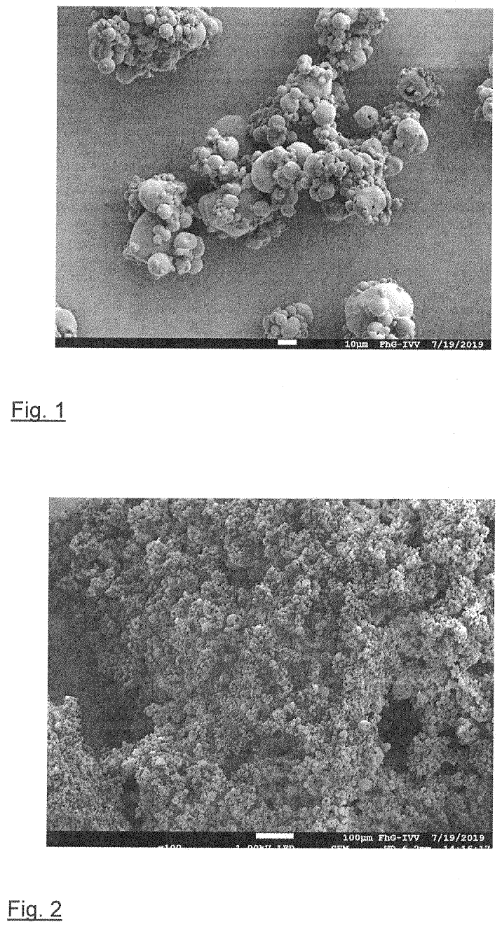

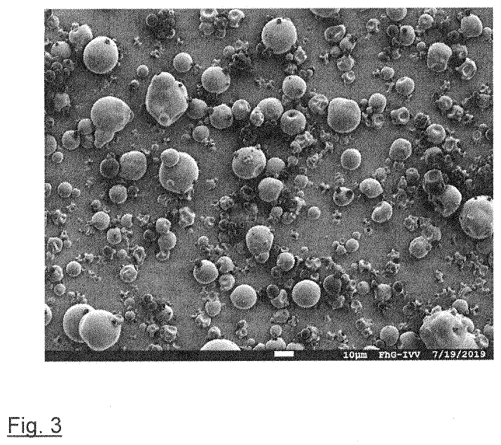

The production of an aqueous mixture of dissolved saccharides and dissolved or suspended proteins and/or peptides leads to a further advantage during spray drying. Thus, during spray drying a high proportion of aggregates consisting of many individual particles is created following the addition of saccharides and/or lactic acid, wherein in the dried preparation more than 10 mass percent, advantageously more than 20 mass percent, particularly advantageously more than 50 mass percent of aggregates are contained which consist of more than 20 linked single particles, advantageously more than 50 single particles, particularly advantageously more than 100 single particles which have a diameter greater than 1 μm (FIG. 1). With a particularly high lactic acid content, which may be achieved by adding more or by fermentation lasting longer than 12 hours, advantageously more than 24 hours, even more than 10 mass percent is formed, advantageously more than 20 mass percent, particularly advantageously more than 50 mass percent of aggregates made up of more than 10,000 single particles (FIG. 2). In comparison with this, the portion of aggregates that consist of more than 20 single particles in saccharide-free preparations is appreciably below 10 mass percent (FIG. 3).

The drawings show:

FIG. 1: An electron microscope image of a soy protein preparation according to the invention with a saccharide fraction of 20 mass percent and a lactic acid content less than 1.0 mass percent;

FIG. 2: An electron microscope image of a soy protein preparation according to the invention with a saccharide fraction of 3 mass percent and a lactic acid content of about 2 mass percent; and

FIG. 3: An electron microscope image of a conventional soy protein preparation with no added saccharides and with no added lactic acid or lactic acid-binding microorganisms.

This proportion of aggregates consisting of many single particles in the preparation has the advantage that the preparation is much more easily dispersible in water than fine, isolated particles without saccharides (as in FIG. 3). This is advantageous for the dosing of the preparation in production and for avoiding the creation of dust during dosing.

After the drying, the aggregates formed can be reduced in size again by mechanical processes (grinding, flaking, . . . ). However, it is not possible for mechanical processes to bring about any separations as shown in FIG. 3, because the microstructures of the agglomerates are preserved. Consequently, the advantages of the preparation, such as reduce dust formation or sensory advantages are entirely or partly retained.

Since it is difficult to determine the drying temperature in an inhomogeneous bulk material or a drying substrate in a dryer, the temperature cited above is understood to be the maximum prevailing temperature while drying in the dryer and to which the plant protein preparation to be dried is exposed in the course of the drying process. Thus for example the highest temperature may be the product exit temperature when drying with microwaves, or the inlet temperature at which a heat transfer medium (e.g., steam, air) enters a convection dryer, or also the maximum belt or roller temperature prevailing before the plant protein preparation suspension is applied.

Surprisingly, it was found that despite the high temperature of over 170° C. in some cases of contact, radiation or convection drying, the good functional properties of the plant protein preparation are largely preserved, and consequently that the sensory optimisation achieved by drying only seems to have a minor effect on the functionality.

Thus, even after drying at temperatures above 150° C., the emulsifying capacity still remains at values above 400 ml oil/g, advantageously over 500 ml oil/g, particularly advantageously over 650 ml oil/g, the foaming activity at over 700%, advantageously over 1000%, particularly advantageously over 1700%, and the protein solubility in pH 7 at over 30%, advantageously over 50%, particularly advantageously over 65%.

The colour of the plant protein preparation according to the invention is also very appealing despite the high temperatures. Accordingly, L*a*b* colour space L* values above 70, advantageously above 80, particularly advantageously above 90 are measured for the plant protein preparation according to the invention after spray drying. The a* value is advantageously in the range 0 to 2 and the b* value in the range 7 to 15, which lends the preparation a pleasantly bright, yellowish-beige appearance and renders it suitable for use in colour-sensitive foodstuff applications such as drinks, yoghurt or cream, for example.

After production of a 10% suspension (w/w) in demineralised water, the L* value of a sample quantity of 30 g when poured into a beaker with a diameter of 56 mm to a fill level of 11 mm is over 55, advantageously over 60, particularly advantageously over 65, the a* value is in the range 5 to 10 and the b* value is in the range 20 to 30.

Volatile aromas are also removed with the steam in air temperatures above 120° C., advantageously above 150° C., particularly advantageously in temperatures above 170° C., and new aromas are generated, produced by the reaction of the individual components such as the proteins and saccharides at the high temperatures, and which are perceived as being particularly attractive by respondents in taste tests, unlike plant protein preparations that were dried gently.

These aromas are particularly distinctive when the saccharide contents in the plant protein preparation are at levels from 2-40%, preferably 10-30%, particularly preferably 5-25%. At such concentrations, the aroma of the plant protein preparations is changed significantly at correspondingly high temperatures. This change mostly described as positive.

Because of the significantly improved sensory characteristics and the significant reduction of aromas described as typical of vegetation, even in the event of a decrease in the functionality of the plant protein preparation resulting from the thermal load during the drying process, it is still possible to guarantee the required functionality with a larger proportion of the plant protein preparation in a food formulation without engendering negative sensory effects a (e.g., a beany smell, bitter taste) in the food. Therefore, the plant protein preparation is advantageously used in the application at a level of more than 2%, particularly advantageously more than 3%. This is not possible with plant protein preparations according to the related art without sensory sacrifice due to their plant-like aroma profile.

Further improvements in the flavour and aroma profile may be gained by adding aromas to the plant protein preparation, which may be found for example in fermented foodstuffs according to the related art for example. Thus, an addition of diacetyl, which may form during fermentation of lactic acid, may produce an aroma profile similar to milk. In conjunction with the aforementioned neutral sensory properties according to the invention, this makes it possible to produce particularly appealing milk substitute products.

In order to ensure that a larger proportion of the single particles which may combine to form aggregates undergo the Maillard reaction during drying, the single particles should be as small as possible to ensure better heat transfer. The D90 value (90% of the particles numerically are less than the value) should advantageously be less than 20 μm, particularly advantageously less than 10 μm, particularly advantageously less than 5 μm. This contributes to a further taste-related change in the application. The particle size can be adjusted during spray drying by the droplet size and protein/peptide concentration in the aqueous suspension that is to be dried. Apart from the protein/peptide concentration, in order to vary the droplet size the flow velocity in the nozzle may also be varied, or the nozzle geometry, or by using other specific settings of the dryer which influence the droplet size. The plant protein preparation according to the invention is further characterized in that the allergic potential of the soy proteins is significantly reduced. Accordingly, antibody binding in the sandwich ELISA was found to be weaker than in a comparison protein preparation obtained from soybeans by aqueous extraction and drying, that is to say a protein preparation obtained without hydrolysis or the addition or further substances such as sugar, microorganisms or lactic acid, for example. In this respect, the bond in the plant protein preparation according to the invention is reduced by between 10 and 90%, preferably between 40 and 90%, particularly preferably between 60 and 90% in terms of binding of specific antibodies to the two amino acid sequences D-E-G-E and D-A-N-I-E-L (symbols according to single letter amino acids code) contained in the Glym5 protein, wherein a bond can no longer be detected in the event that one of the two or both sequences are no longer contained in the protein. The reduction of the allergic potential is confirmed in the prick test (for a description of the prick test refer to the determination procedure).

Here it was found that pricking with the preparation according to the invention gave rise to a welt size of the skin reaction <3 mm, preferably <2 mm, particularly preferably <1 mm in individuals allergic to soy, whereas a prick test with a largely untreated standard soy protein preparation on the same patient produced welt sizes >4 mm, more particularly >5 mm.

| | Welt size | | |
|---|---|---|---|
| | of the | | Particularly |
| | skin reaction | Preferably | preferably |
| Preparation | [mm] | [mm] | [mm] |
| Conventional standard | 7-2 | | |
| protein used to diagnose an | | | |
| allergy to soy. | | | |
| Conventional soy protein | 8-2 | 2-5 | 3-4 |
| preparation with no added | | | |
| saccharides and with no | | | |
| added lactic acid or lactic | | | |
| acid-binding microorganisms | | | |
| Hydrolysed protein | 1-5 | 1-4 | 1-3 |
| preparation with a saccharide | | | |
| fraction of 3% by mass and a | | | |
| lactic acid fraction less than | | | |
| 1.0% by mass | | | |
| Soy protein preparation | 0-4 | 0-3 | 0-2 |
| according to the invention | | | |
| with a saccharide fraction of | | | |
| 20% by mass and a lactic | | | |
| acid fraction less than 1.0% | | | |
| by mass immediately after | | | |
| spray drying | | | |
| Soy protein preparation | 0-3 | 0-2 | 0-1 |
| according to the invention | | | |
| with a saccharide fraction of | | | |
| 3% by mass and a lactic acid | | | |
| fraction of about 2% by mass | | | |
| immediately after spray | | | |
| drying | | | |

The plant protein preparation according to the invention is advantageously incorporated in foodstuffs, for example in emulsions such as cream, milk, yoghurt, sausage and the like, in gels such as sausage products, meat alternatives, for protein enrichment or as a soluble or suspended component in drinks. The preparation may also be used in foods which have been declared hypoallergenic, because the fraction of hydrolysed products in the preparation and the formation of aggregates during the drying result in lower allergenicity than with native proteins such are present after extraction from plant seeds.

Moreover, their use in pet foods is advantageous because the weak impression of a plant aroma is also preferred by dogs and cats. Use of the preparation is also recommended for livestock to achieve good growth rates due to the proportion of easily digestible hydrolysed proteins.

### Example Procedure 1

A soy protein fraction was prepared by extraction with water at pH 7.5 from soybeans that had been flaked and de-oiled with hexane and was concentrated by precipitation at the isoelectric point. The suspension thus obtained was neutralised and adjusted to a protein content of 5%.

This was followed by enzymatic hydrolysis with an endopeptidase and an exopeptidase to obtain the desired molecular weight distribution of proteins and peptides, pasteurisation at 90° C. and the addition of sucrose until a protein:sucrose ratio of 4:1 was obtained. This was followed by drying of the preparation in a hot airflow at 170° C. to a residual moisture of 10%.

The plant protein preparation obtained thereby had an appealing sensory profile with a mild caramel note and had the following technofunctional properties:

| Parameter | Unit | Value |
|---|---|---|
| Solubility at pH 7 | % | 68 |
| Emulsifying capacity | ml oil/g | 683 |
| Foaming activity | vol. % | 1775 |
| Foaming stability | vol. % | 82 |
| Water binding | g/g protein | 0.5 |
| Oil binding | g/g protein | 1.2 |

### Example Procedure 2

A 5% suspension of a soy protein fraction was prepared as described in Example 1. This was followed by enzymatic hydrolysis with an endopeptidase and an exopeptidase to obtain the desired molecular weight distribution of proteins and peptides, pasteurisation at 90° C., the addition of sucrose until a protein:sucrose ratio of 5:1 was obtained 5:1 and addition of lactic acid to a lactic acid concentration of 3% relative to the total DS content of the protein fraction used. The preparation was then dried in the hot air stream at 170° C. to a residual moisture of 10%. The preparation obtained thereby had an appealing sensory profile with a slightly sour note and a mild caramel note. The plant protein preparation exhibited similar functional properties to those in Example 1.

### Example Procedure 3

A Lactobacillus strain was added in a concentration of 10\hat{ }8 colony forming units per gram (CFU/g) suspension to the suspension of hydrolysed soy protein according to Example 2 with a protein:sucrose ratio of 5:1. This was followed by fermentation at 37° C. for 4 hours and drying of the preparation on a hot belt with a belt temperature of 130° C. until a residual moisture of 8% was reached. The dry preparation was then comminuted to a particle size smaller than 250 μm. The plant protein preparation obtained thereby had an appealing sensory profile with a slightly sour, cheesy and milky note and a mild caramel note, and had the following technofunctional properties:

| Parameter | Unit | Value |
|---|---|---|
| Solubility at pH 7 | % | 54 |
| Emulsifying capacity | ml oil/g | 600 |
| Foaming activity | vol. % | 1646 |
| Foaming stability | vol. % | 90 |
| Water binding | g/g protein | 1.2 |
| Oil binding | g/g protein | 1.1 |

### Assay Methods

In order to establish a quantitative characterization of the plant protein preparation obtained, the following assay methods are used:

Protein Content:

The protein content is defined as the content which is calculated by determining the nitrogen (N) and multiplying this by the factor 6.25. The protein content is expressed for example as a percentage relative to the dry mass (DS).

Molecular Weight Distribution:

The molecular weight distribution is defined using assay methods (in this case called SDS-PAGE analysis) as described in: Laemmli, “Cleavage of structural proteins during assembly of head of bacteriophage-T4”. Nature, 227, 680). The cleavage of the proteins is carried out using 4-20% midi Criterion™ TGX Stain-Free™ precast gels (Bio-Rad Laboratories, Munich, Germany) in the Criterion™ Cell (Bid-Rad Laboratories, Munich, Germany) under reducing conditions, and display and semiquantitative evaluation is performed using for example the gel Doc™ EZ Imager (Bio-Rad Laboratories, Munich).

Protein Solubility (at pH 7 or pH 4):

In order to determine protein solubility, the plant protein preparation in a weight-volume percentage from 1:25 to 1:50 (w/v) (i.e. 1-2 g of the plant protein preparation to 50 ml solution) is suspended in a 0.1 M NaCl solution at room temperature and maintained at a pH value of pH 7 (or pH 4) for approx. 60 min using 0.1 M HCl- or NaOH solution and stirred at approx. 200 rpm, and the insoluble sediment is subsequently centrifuged for 15 min at 20,000 RCF (Relative Centrifugal Force). Protein solubility is expressed e.g. in percent, wherein a protein solubility of x % means that x % of the protein present in the plant protein preparation will be recovered from the clear supernatant if the method described is used.

Water Conditions: The water binding capacity can be expressed for example in ml/g, i.e. millilitres of the demineralised bound water added in surplus (1:20) per gram of plant protein preparation. It is determined based on the weight of the sediment saturated with water [g] less the sample weight of the dry plant protein preparation of 2 g and by dividing this value by the sample weight of the dry plant protein preparation [2 g] multiplied by the dry substance of the plant protein preparation [%] after thorough mixing for 1, sedimentation for 5 minutes, shaking vigorously for 30 seconds, repeat sedimentation for 5 minutes, repeat vigorous shaking for 30 seconds and centrifuging at 1000 RCF (Relative Centrifugal Force) for 15 minutes at room temperature. The weight of the sediment saturated with water or the plant protein preparation saturated with water is determined by weighing back the centrifuge tube.

Oil Binding Capacity:

The oil binding capacity is expressed e.g. in ml/g, i.e. millilitres of bound oil per gram plant protein preparation and corresponds to the volume of the oil-binding sediment. Exactly 1.50 g of the plant protein preparation is weighed into the graduated 15 ml centrifuge tube and 10 ml Mazola corn oil is added. After mixing thoroughly for 1 minute, centrifuging at 700 RCF (Relative Centrifugal Force) for 15 minutes at room temperature and separating the supernatant, the unbound oil is determined using the graduation on the centrifuge tube. In order to determine the oil binding capacity, expressed in ml/g for example, the value of the unbound oil [ml] is deducted from the 10 ml of oil initially added, and this value is divided by the sample weight 1.50 g of the plant protein preparation.

Emulsifying Capacity:

In order to determine the emulsifying capacity corn oil is added to a 1% suspension of the plant protein preparation at pH 7 until phase inversion of the oil-in-water emulsion can be measured. The emulsifying capacity is defined as the maximum oil absorption capacity of this suspension, as determined by the spontaneous fall in conductivity at phase inversion and is expressed for example in ml oil/g, i.e. millilitres of emulsified oil per gram of plant protein preparation.

Foaming Activity:

Foaming activity is expressed in percent, measured as the increase in volume of a 5% plant protein preparation dispersion, pH 7, when beaten with a whisk (wire whisk) for 8 Min on level 3 (591 rpm) in a Hobart 5ON Standard food processor (steel bowl with 5 litre capacity).

Foam Stability:

Foam stability is expressed in percent, measured as the volume left over from 100 ml foam one hour after beating a 5% sample suspension, pH 7 for 8 min on level 3 (591 rpm) in a Hobart 5ON Standard food processor (steel bowl with 5 litre capacity).

Immunoreactivity:

Immunoreactivity is defined by assay methods (Sandwich ELISA) as indicated: Meinlschmidt P, et al., “Immunoreactivity, sensory and physicochemical properties of fermented soy protein isolate”, Food Chemistry 205: 229-238.

Prick Test:

The prick test is used to detect a “type I allergy”. For this, a defined allergen extract is deposited on the skin and this is then gently pricked with a lancet so that the respective substance can penetrate the epidermis. The test reaction is read off after 20 min in comparison with a positive control with histamine, a negative control containing no active ingredients. A test reaction is considered positive in the prick test if an average welt diameter of 3 mm, or 5 mm in the intracutaneous test is raised (guideline of the Deutsche Gesellschaft für Allergologie and klinische Immunologie [German Society for Allergology and clinical Immunology] DGAKI).
The microorganisms can be quantified using microscope techniques or by quantifying the DNA strands of the microorganisms contained in the plant protein preparation. The DNA strands are quantified with a method taken from molecular biology which is known by the name “Quantitative PCR”. The amount of DNA in the residue is calculated using quantitative PCR and can therefore be correlated with the cell count used originally. The dry mass of the microorganisms can be derived from this.
The colony number “colony forming unit”, CFU of various lactic acid bacteria per millilitre of suspension [CFU/ml] is determined under sterile conditions by plating on selective culture media. First, a decimal dilution series of the sample containing lactic acid bacteria is prepared in Ringer solution as far as the dilution level at which a colony number between 10 and 300 CFU is reached. 100 μl each of the corresponding dilution level are pipetted onto a slide with MRS agar and spread by circling motions using a Drigalski spatula. The slides are incubated for 2-3 days, either aerobically or anaerobically depending on the germ type, and at the incubation temperature specific to the germ. After the incubation period, the colonies are counted, and the weighted arithmetical mean from the countable dilution stage is determined using the following equation (1):

$$\overline{c} = \frac{\sum c}{{n}_{1} \times 1 + {n}_{2} \times 0 , 1} \times d \qquad ( 1 )$$

c̅ weighted arithmetical mean of the colony numbers
Σc sum of colonies from all Petri dishes which are included in the calculation
V vol. of NaCl solution with dissolved protein [ml]
n₁ no. of Petri dishes at the lowest dilution level able to be evaluated
n₂ no. of Petri dishes at the next higher dilution level
D factor of the lowest dilution stage evaluated; this is the dilution level relative to n₁
   Colour: The perceptible colour is defined using CIE-L*a*b* colorimetry under standardised light conditions (see DIN 6417). The L* axis indicates brightness, wherein Black has value 0 and White has value 100, the a* axis describes the Green or Red component, and the b* axis describes the Blue or Yellow component.

Sensory Properties:

Sensory tests, in which trained testers compare a certain taste or aroma impression of the plant protein preparation and a suitable reference substance and rate it on a scale from 1 to 10 (1=not perceptible, 10=strongly perceptible), wherein two reference substances are selected in such a way that the flavour or aroma impression to be tested for them are rated with 5 and 10.

Examples of flavour or aroma impressions to be tested are:
beany flavour compared with soybeans;
green to grassy flavour compared with green bell pepper or green peas;
bitter flavour compared to two aqueous, 1.0 and 2.5% aqueous solutions of alcalase hydrolysate (manufacturing conditions: E/S=0.5%, 180 min, pH 8.0, 60° C., no pH value regulation). The panel was selected previously using a sensory threshold test for identifying “Bitter and non-bitter tasters” with the aid of caffeine solutions.
Determination of Maillard products: Hydroxymethyl furfural (HMF) and Strecker aldehydes

Following a SAFE extraction of the plant protein preparation, the HMF and the Strecker aldehydes (3-Methylbutanal, 2-Methylbutanal, methional, benzaldehyde and 2-Phenylacetaldehyde) of the solvent phase are analysed by gas chromatography with a flame ionisation detector (GC-FID) and quantified using stable isotope standards.

1. Plant protein preparation made of soybeans, which has a mixture of proteins and/or constituents of proteins of the soybeans as the main component and a mass fraction between 2 and 40% of saccharides from the group of mono-, di- and/or oligosaccharide with up to 4 monomer units,
wherein a molecular weight distribution of proteins and peptides determined by SDS-Page exists in the mixture of proteins and/or constituents of proteins, in which a mass fraction between 50 and 100% has a molecular weight <20 kDa, a mass fraction between 0 and 30% has a molecular weight between 20 kDa and 45 kDa, and a mass fraction between 0 and 20% has a molecular weight of >45 kDa.

2. Plant protein preparation according to claim 1,
characterized in that
in the molecular weight distribution a mass fraction between 70 and 100% has a molecular weight <20 kDa, a mass fraction between 0 and 20% has a molecular weight between 20 kDa and 45 kDa, and a mass fraction between 0 and 10% has a molecular weight of >45 kDa.

3. Plant protein preparation according to claim 1,
characterized in that
in the molecular weight distribution a mass fraction between 83 and 100% has a molecular weight <20 kDa, a mass fraction between 0 and 13% has a molecular weight between 20 kDa and 45 kDa, and a mass fraction between 0 and 4% has a molecular weight of >45 kDa.

4. Plant protein preparation according to claim 1,
characterized in that
the mass fraction of saccharides constitutes between 10% and 30%, preferably between 20% and 25%.

5. Plant protein preparation according to claim 1,
characterized in that
the plant protein preparation contains a portion of acid-generating microorganisms, in particular from the group of homo- and heterofermentative lactic acid bacteria.

6. Plant protein preparation according to claim 1,
characterized in that
the plant protein preparation contains a portion of organic acids and/or salts of organic acids.

7. Plant protein preparation according to claim 1,
characterized in that
the plant protein preparation contains a mass fraction of lactic acid between 0.05 and 10%, advantageously between 0.1% and 2%, particularly advantageously between 0.1% and 1.5%.

8. Plant protein preparation according to claim 5,
characterized in that
the mass fraction of acid-generating microorganisms—converted into dry mass of the microorganisms—is between 1 and 1000 mg per kg dry mass of the plant protein preparation, advantageously between 1 and 100 mg/kg, particularly advantageously between 10 and 50 mg/kg.

9. Plant protein preparation according to claim 1,
characterized in that
the plant protein preparation has an emulsifying capacity greater than 400 ml oil/g, advantageously greater than 500 ml oil/g, particularly advantageously greater than 650 ml oil/g.

10. Plant protein preparation according to claim 1,
characterized in that
the plant protein preparation has a foaming activity of more than 700%, advantageously more than 1000%, particularly advantageously more than 1700%.

11. Plant protein preparation according to claim 1,
characterized in that
the plant protein preparation has a protein solubility at pH 7 of more than 30%, advantageously more than 50%, particularly advantageously more than 65%.

12. Plant protein preparation according to claim 1,
characterized in that
according to CIE-L*a*b* colorimetry the plant protein preparation has a value for L* of >70, advantageously >80, particularly advantageously >90.

13. Plant protein preparation according to claim 12,
characterized in that
according to CIE-L*a*b* colorimetry the plant protein preparation has a value for a* in the range from 0 to 2 and a value for b* in the range from 7 to 15.

14. Plant protein preparation according to claim 1,
characterized in that
the plant protein preparation consists of particles of which 90% are smaller than 20 μm, advantageously smaller than 10 μm, particularly advantageously smaller than 5 μm.

15. Plant protein preparation according to claim 1,
characterized in that
the plant protein preparation contains aggregates consisting of single particles,
wherein a portion of aggregates made up or more than 20 linked single particles with a diameter greater than 1 μm, advantageously more than 50 single particles, particularly advantageously more than 100 single particles, constitutes more than 10% by mass, advantageously more than 20% by mass, particularly advantageously more than 50% mass of the dry substance of the plant protein preparation.

16. Plant protein preparation according to claim 1,
characterized in that
the plant protein preparation contains aggregates consisting of single particles,
wherein a portion of aggregates made up or more than 10,000 linked single particles with a diameter greater than 1 μm constitutes more than 10% by mass, advantageously more than 20% by mass, particularly advantageously more than 50% by mass of the dry substance of the plant protein preparation.

17. Plant protein preparation according to claim 1,
characterized in that
the plant protein preparation contains a portion of proteins and peptides of soybeans that are water-soluble at pH 4.5, which is less than 10%, advantageously less than 5%, particularly advantageously less than 1% relative to the total mass of proteins and peptides in the plant protein preparation.

18. Plant protein preparation according to claim 1,
characterized in that
the plant protein preparation contains a portion of hydroxymethyl furfural (HMF) which is between 0.5 mg/kg and 600 mg/kg dry substance, advantageously between 0.5 and 400 mg/kg, particularly advantageously between 0.5 and 250 mg/kg dry substance.

19. Plant protein preparation according to claim 1,
characterized in that
in the Sandwich ELISA the plant protein preparation exhibits reduced binding of antibodies compared with a comparison protein preparation obtained from soybeans by means of aqueous extraction and drying, wherein the binding of the plant protein preparation is between 10 and 90%, preferably between 40 and 90%, particularly preferably between 60 and 90% lower in the Sandwich-ELISA in terms of the binding of specific antibodies to the two amino acid sequences D-E-G-E and D-A-N-I-E-L (symbols according to single letter amino acids code) contained in the Glym5 protein,
wherein a bond can no longer be detected in the event that one of the two or both sequences are no longer contained in the protein.

20. A process for producing a plant protein preparation from soybeans comprising:
providing a protein fraction of the soybeans in aqueous suspension, which contains a mixture of proteins and/or constituents of proteins from the soybeans,
hydrolysing the protein fraction to obtain a molecular weight distribution of proteins and peptides in the protein fraction determined by means of SDS-Page, in which a mass fraction between 50 and 100% has a molecular weight <20 kDa, a mass fraction between 0 and 30% has a molecular weight between 20 kDa and 45 kDa, and a mass fraction between 0 and 20% has as molecular weight of >45 kDa,
adding sugar containing saccharides from the group of mono-, di- and/or oligosaccharide with up to 4 monomer units, to the aqueous suspension, and
drying the aqueous suspension at a drying temperature of >120° C.,
wherein the saccharides are added to the aqueous suspension in a quantity such that after drying, the saccharides in the plant protein preparation constitute a mass fraction between 2 and 40% of the plant protein preparation.

21. Process according to claim 20,
characterized in that
the drying temperature is >150° C., preferably >170° C.

22. Process according to claim 20,
characterized in that
drying is carried out by means of spray drying with inlet temperatures >120° C., advantageously >150° C., particularly advantageously >170° C., and outlet temperatures from 50-100° C.

23. Process according to claim 20,
characterized in that
lactic acid is added to the aqueous suspension before the drying.

24. Process according to claim 20,
characterized in that
addition of acid-generating microorganisms, in particular from the group of homo- and heterofermentative lactic acid bacteria to the aqueous suspension with subsequent fermentation takes place before the drying.

25. Process according to claim 24,
characterized in that
after the hydrolysis the suspension is divided into at least two parts, the addition of the microorganisms and the sugar to the different parts is made in different concentrations, or microorganisms are not added to one of the parts, and the at least two parts are mixed again after the fermentation.

26. Process according to claim 20,
characterized in that
the hydrolyse is carried out in the form of an enzymatic hydrolysis, in particular with an endopeptidase and an exopeptidase.

27. Process according to claim 20,
characterized in that
initially an extraction and separation of a part of the proteins and peptides contained in the soybeans is made before the provision of the protein fraction of the soybeans in aqueous suspension, which can be washed out from mechanically crushed soybeans in water at 20° C. and with a pH of 4.5, so that the protein fraction supplied subsequently for hydrolysis then no longer contains this part.
